(19) United States
(12) Patent Application Publication
(10) Pub. No.: US 2008/0194291 A1
(43) Pub. Date: Aug. 14, 2008

(54) Device and method for remotely operating keyless entry systems

(76) Inventors: Robert C. Martin, Lincoln, NE (US); Susan E. Miller, Lincoln, NE (US)

Correspondence Address: JAMES RAY & ASSOCIATES, 2640 Pitcairn Road, Monroeville, PA, 15146, US

(21) Appl. No.: 12/011,276

(22) Filed: Jan. 26, 2008

Related U.S. Application Data
(60) Provisional application No. 60/886,966, filed on Jan. 29, 2007.

(51) Int. Cl. H04M 1/00

(52) U.S. Cl. 455/556.1

(57) ABSTRACT

A mobile communication device for remotely operating a keyless entry system includes a processor for generating at least one coded signal based on a predetermined code and a predetermined frequency entered by a user and a transmitter coupled to the processor for transmitting the generated coded signal. The at least one coded signal carries a code which is substantially identical to an operating code stored within the keyless entry system, whereby operation of the keyless entry system is responsive to a receipt of the at least one coded signal. To generate and transmit such at least one coded signal a dedicated switch may be provided within the mobile communication device and manually operable by the user or the user may utilize the key pad and functional keys.

### CROSS-REFERENCE TO RELATED APPLICATIONS

This application is related to and claims priority from Provisional Patent Application Ser. No. 60/886,966 filed on Jan. 29, 2007.

### FIELD OF THE INVENTION

The present invention relates, in general, to remote control devices and, more particularly, this invention relates to remotely operating a keyless entry system using mobile communication device and, yet more particularly, the instant invention relates to a method of using a mobile communication device to operate a plurality of keyless entry systems.

### BACKGROUND OF THE INVENTION

It is generally well known in the art to use remote controllers to open and close various doors. One well known example of such remote operation is a garage door system that includes a powered drive and a control device. In operation, the control device is responsive to a receipt of a coded signal, usually of a radio frequency (RF) signal type, transmitted from a remote controller to open or close the garage door. The remote controller for the garage door is generally located within a vehicle so that the user of such vehicle can conveniently open and close the garage door while remaining inside the vehicle. Often, when the vehicle is cleaned, the remote controller may be misplaced, lost or damaged. Furthermore, the remote controller is capable, for security reasons, of operating only one garage door system. Thus, individuals tasked with opening more than one garage door, are burdened by logistics of using multiple remote controllers and remembering or marking each remote controller to be used with a respective garage door system.

Likewise, many entry doors in a residential or commercial dwellings are now equipped with keyless entry devices and require a dedicated controller. Finally, vehicles are extensively provided with keyless entry systems which require a dedicated wireless remote control device called “fob” that transmits infra-red (IR) or RF signals to the vehicle control system.

Accordingly, with proliferation of electronic keyless entry systems, any individual is disadvantaged by the need of using and maintaining multiple remote controllers, each dedicated to operate a distinct keyless entry system.

Therefore, there is a need for an improved device and method for operating a keyless entry system and, more particularly, for operating a plurality of keyless entry systems.

### SUMMARY OF THE INVENTION

According to one embodiment, the invention provides a method of remotely operating a keyless entry system. The keyless entry system has a control unit capable of receiving a coded signal and comparing a code stored therewithin with an operating code stored within the control unit. The method includes the step of providing a mobile communication device having a transmitter means disposed therein for transmitting the coded signal to the control unit. Then, programming, within the mobile communication device, a code which is substantially identical to the operating code stored within the control unit. Next, generating, within the mobile communication device, the coded signal having the code stored therein. Transmitting, with the mobile communication device, the coded signal to the control unit. Then, receiving, at the control unit, the coded signal transmitted from the mobile communication device. Next, comparing, with the control unit, the code stored within the received coded signal with the operating code stored within the control unit. Finally, operating, according to a predetermined logic algorithm stored within the control unit, the keyless control system when the transmitted code matches the operating code stored within the control unit.

According to another embodiment of the invention, there is provided a method of remotely operating a plurality of keyless garage door entry systems. Each garage door system has a door mounted for movement in opening or closing direction. A powered drive mechanism is coupled to the door for moving it in an opening and closing directions. A control unit is coupled to the powered drive mechanism and is capable of receiving a coded signal and comparing a code stored therewithin with an operating code stored within the control unit. The method includes the step of providing a mobile communication device having a transmitter means disposed therein for transmitting at least one coded signal. Then, programming, within the mobile communication device, a plurality of codes each corresponding to an operating code stored within the control unit of a respective keyless garage door entry system. Next, selecting, with the mobile communication device, a code to be transmitted. Generating, within the mobile communication device, the coded signal having the code stored therein. Next, transmitting, with the mobile communication device, the coded signal to the respective keyless garage door entry system. Then, receiving, at the control unit, the transmitted coded signal. Comparing, with the control unit, the code stored within the received coded signal with the operating code stored within the control unit. Finally, controlling, with the control unit, the powered drive mechanism to move the door in the opening or closing direction when the transmitted code matches the operating code stored within the control unit.

According to a yet another embodiment, the invention provides a mobile communication device for remotely operating a keyless entry system. The mobile communication device further includes means for generating and transmitting at least one of a radiofrequency and infrared coded signal and operating means operable by a user for operating the coded signal generating and transmitting means. The at least one coded signal carries a code which is substantially identical to an operating code stored within the keyless entry system. Consequently, operation of the keyless entry system is responsive to a receipt of the at least one coded signal.

### OBJECTS OF THE INVENTION

It is, therefore, one of the primary objects of the present invention to provide a mobile communication device that is capable of operating a keyless entry system.

Another object of the present invention is to provide a mobile communication device that is capable of securely operating a keyless entry system.

Yet another object of the present invention is to provide a mobile communication device that that can be programmed by a user to transmit a coded radiofrequency (RF) signal or an infrared (IR) signal for securely operating a keyless entry system.

A further object of the present invention is to provide a mobile communication device for operating a keyless entry system that includes a dedicated user-operable switch for operating such keyless entry system.

Yet a further object of the present invention is to provide a mobile communication device for operating a keyless entry system that requires the user to enter a predetermined user code.

An additional object of the present invention is to provide a mobile communication device that is capable of operating a plurality of keyless entry systems.

Another object of the present invention is to provide a method of operating keyless entry system by using a mobile communication device.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an isometric view of a mobile communication device of the present invention;

FIG. 2 is a schematic block diagram of the mobile communication device of FIG. 1 in use for remotely controlling operation of a garage door;

FIG. 3 is an environmental view of the mobile communication device of FIG. 1 shown for remotely opening a garage door; and

FIG. 4 is an environmental view of the mobile communication device of FIG. 1 shown in combination with a partially opened garage door.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a mobile communication device includes but is not limited to phones, personal digital assistants (PDAs), pagers, portable computers and the like devices.

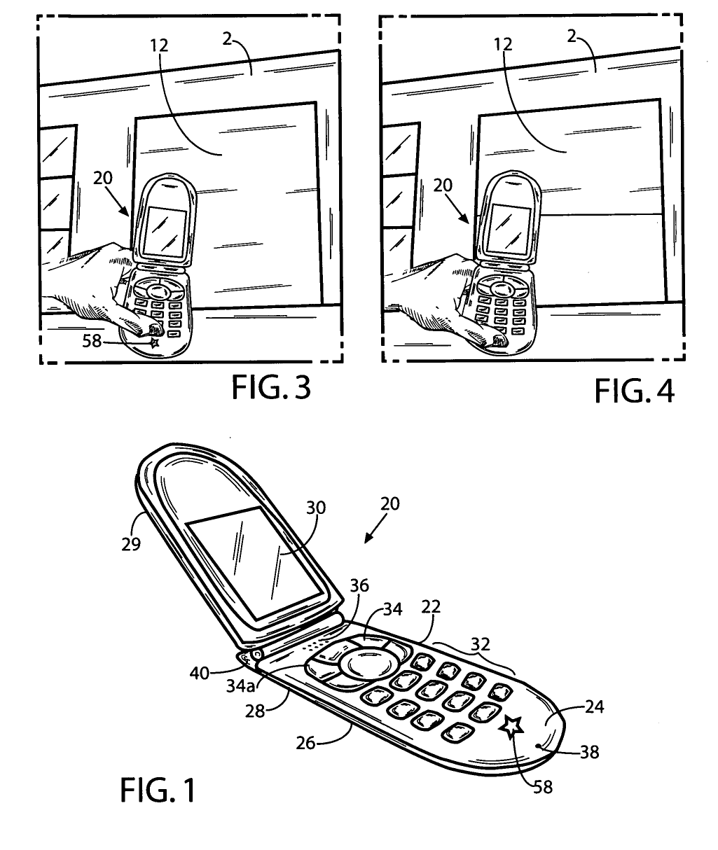

The best mode for carrying out the invention is presented in terms of its presently preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The structure and operation of the present invention will be explained in combination with opening and closing a garage door system, generally designated as 10.

Conventionally, the garage door system 10 includes a door 12 mounted for movement in opening or closing direction, a powered drive mechanism 14 for moving the door 12 and a control unit 16 coupled to the powered drive mechanism 14 and capable of receiving a coded signal, comparing a code stored therewithin with an operating code stored within the control unit 16 and activating the drive mechanism 14 according to a predetermined logic algorithm when the received code matches the operating code stored within the memory of the control unit 16.

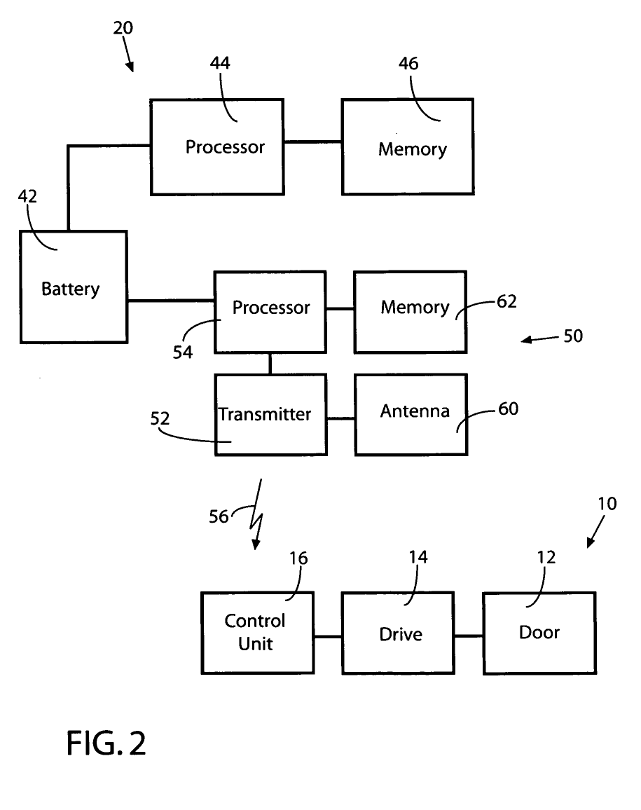

Reference is now made, to FIGS. 1-2, wherein there is shown a hand held mobile communication device, generally designated as 20. The mobile communication device 20 includes a housing 22 having a first surface 24, an opposed second surface 26 and a peripheral edge 28 and may include an optional cover 29. In a conventional manner, the device 20 includes a display 30, an alpha-numeric key pad 32 having a plurality of keys, a functional control key arrangement 34 having a plurality of functional control keys, a speaker 36, a microphone 38 and antenna 40. The above components can be arranged and disposed on surfaces 24, 26, peripheral edge 28 and cover 29 in any manner presently employed in a construction of hand held mobile communication devices. The display 30 may be of a conventional liquid crystal display (LCD) type. A battery 42, a processor means 44 (including a software and firmware) and a memory 46 are disposed internal to the housing 22. As is generally known, the processor means 44 is capable of executing a computer program code.

An improvement to the device 10 includes means, generally designated as 50, for transmitting a coded signal of a predetermined frequency. The signal may be of infrared (IR) type and, preferably, the signal is of a radiofrequency (RF) type. Accordingly, such RF transmitter means 50 includes a transmitter 52. A processor 54 (including a software and firmware) is provided and is capable of generating a coded signal 56 based on a predetermined code and a predetermined frequency associated therewith. The processor 54 is coupled to the transmitter 52 and triggers it, upon receiving the user code. The transmitter 52 then transmits such coded signal 56 to the control unit 16 in response to the processor 54. Preferably, both the transmitter 52 and the processor 54 are integrated into the processor means 44 of the mobile communication device 20 and the antenna 40 is employed to transmit such coded signal 56 to the control unit 16. However, it is within the scope of the present invention to provide an independent processor 54 and provide a second antenna 60 which is then coupled directly to the transmitter 52.

According to one embodiment, the present invention provides a switch 58 which is coupled to the processor 54 and which is operable by the user to activate the transmitter 52 to transmit the coded signal 56. Although, the switch 58 has been provided on the first surface 24 of the housing 22, as best depicted in FIG. 1, it will be apparent to one of ordinary skill in the art that the switch 58 may be mounted anywhere within the mobile communication device 20 and therefore, the location of the switch 58 is not limiting. The switch 58 provides a convenient and simple one-touch means for operating the garage door system 10. Neither limiting will be a type of the switch 58. Although it is illustrated in FIG. 1 as being of a pushbutton type, the switch 58 may be of a “touch” type, optical type, magnetic type and the like.

In order to use the switch 58, the user first uses the key pad 32 and/or functional control key arrangement 34 to “program” the mobile communication device 20 by entering the activation information related to the particular garage door system 10. The activation information includes an operating code which is stored within the control unit 16 and, if required, an operating frequency. This information is then stored within the memory 46 or within a second memory 62 if it is required to be independently provided. Since the functionality of the switch 58 is preprogrammed within the processor 44 or 54, the mobile communication device 20 will be responsive to the operation of the switch 58, manually operable by the user, to transmit the coded signal 56.

According to another embodiment of the present invention, the coded signal 56 is transmitted by way of the key pad 32 and functional control key arrangement 34. To achieve this, the user first uses the key pad 32 and/or functional control key arrangement 34 to “program” the mobile communication device 20 by entering the activation information related to the particular garage door system 10. The activation information includes an operating code which is stored within the control unit 16 and, if required, an operating frequency. This information is then stored within the memory 46 or within a second memory 62 if it is required to be independently provided. The user also enters, using at lest the key pad 32, a user code to be associated with the particular garage door system 10. Such user code is also stored within the memory 46 or 62. When the programming is done and the relative information is stored within the memory 46 or 62, the user can then simply chose a door opening menu from a menu directory provided within the mobile communication device 20, enter the user code and press a predetermined key, by way of an example only, such as the “SEND” key 34a from the functional control key arrangement 34 to operate the particular garage door system 10. Internal to the mobile communication device 20, the entered user code is compared with the previously stored user code and the operation of the transmitter means 50 is enabled only when the entered user code matches the user code stored in memory 46 or 62. It is also contemplated to inform the user of the mobile communication device 20 by way of a predetermined message displayed on the display 30 if the entered user code does not match the user code stored in memory 46 or 62.

Advantageously, the employment of the user code prevents an unauthorized person who gained possession of the mobile communication device 20 and who has information on the physical location of the garage door system 10 to operate the later and gain entry into the dwelling 2 having the garage door system 10 installed therein. Accordingly, it is also contemplated to employ the user code in combination with the switch 58.

It is also within the scope of the present invention to enable the user of the mobile communication device 20 to “program” a plurality of distinct user codes each associated with a distinct garage door system 10 and adapt the transmitter means 50 to generate and transmit a plurality of coded signals 56 each associated with a respective user code in order to operate a plurality of garage door systems 10 in a secure manner. Thus, the user of the mobile communication device 20 utilizes a single device to operate a plurality of keyless entry systems. Another advantage of using the mobile communication device 20 of the present invention is in that it is generally within easy reach of and is closely guarded by the user due to its significance. Therefore, the present invention overcomes disadvantages of lost or misplaced remote garage door openers.

Although the present invention has been shown in terms of employing a mobile communication device for remotely operating a keyless garage door system, it will be apparent to those skilled in the art, that the present invention may be applied to other keyless entry systems, for example, such as a vehicle door, wherein the control unit of the vehicle will control the door lock or a building door, wherein the control unit will control operation (locking or unlocking) of the building door lock.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method of remotely operating a keyless entry system having a control unit capable of receiving a coded signal and comparing a code stored therewithin with an operating code stored within said control unit, said method comprising:
(a) providing a mobile communication device having a transmitter means disposed therein for transmitting said coded signal to said control unit;
(b) programming, within said mobile communication device, a code which is substantially identical to said operating code stored within said control unit;
(c) generating, within said mobile communication device, said coded signal having said code stored therein;
(d) transmitting, with said mobile communication device, said coded signal to said control unit;
(e) receiving, at said control unit, said coded signal transmitted in step (d);
(f) comparing, with said control unit, said code stored within said coded signal received in step (e) with said operating code stored within said control unit; and
(g) operating, according to a predetermined logic algorithm stored within said control unit, said keyless control system when said code transmitted in step (d) matches said operating code stored within said control unit.

2. The method, according to claim 1, wherein said coded signal programming step includes the step of saving said code to memory.

3. The method, according to claim 1, wherein said generating step includes the step of programming, within said mobile communication device, a user code to be associated with said code programmed in step (b), the step of saving said programmed user code to memory and the step of entering, by a user, said user code.

4. The method, according to claim 3, wherein said method includes the additional step of comparing said user code entered by the user with said user code programmed within said mobile communication device.

5. The method, according to claim 4, wherein said method includes the additional step informing the user of said mobile communication device when said entered user code does not match said user code stored within mobile communication device.

6. The method, according to claim 1, wherein said generating step includes the step of operating, by a user, a distinct switch provided on said mobile communication device.

7. The method, according to claim 1, wherein said generating step includes the step of using at least one of an alpha/numeric key and a functional key provided within said mobile communication device.

8. The method, according to claim 1, wherein said transmitting step includes the step of providing an independent antenna within said mobile communication device.

9. A method of remotely operating a plurality of keyless garage door entry systems each having a door mounted for movement in a opening or closing direction, a powered drive mechanism coupled to said door for moving it in an opening and closing directions and a control unit coupled to said powered drive mechanism and capable of receiving a coded signal and comparing a code stored therewithin with an operating code stored within said control unit, said method comprising:
(a) providing a mobile communication device having a transmitter means disposed therein for transmitting at least one coded signal;
(b) programming, within said mobile communication device, a plurality of codes each corresponding to an operating code stored within said control unit of a respective keyless garage door entry system;
(c) selecting, with said mobile communication device, a code to be transmitted;
(d) generating, within said mobile communication device, said coded signal having said code stored therein;
(e) transmitting, with said mobile communication device, said coded signal to said respective keyless garage door entry system;
(f) receiving, at said control unit, said coded signal transmitted in step (e);
(g) comparing, with said control unit, said code stored within said coded signal received in step (f) with said operating code stored within said control unit; and
(h) controlling, with said control unit, said powered drive mechanism to move said door in said opening or closing direction when said code transmitted in step (e) matches said operating code stored within said control unit.

10. The method, according to claim 9, wherein said selecting step includes the step of using a menu provided within said mobile communication device.

11. The method, according to claim 9, wherein said generating step includes the step of entering a user code associated with at least one code programmed in step (b).

12. In combination with a keyless entry system, a mobile communication device for remotely operating the keyless entry system, said mobile communication device further comprising means for generating and transmitting at least one of a radiofrequency and infrared coded signal and operating means operable by a user for operating said coded signal generating and transmitting means, whereby said at least one coded signal carries a code which is substantially identical to an operating code stored within the keyless entry system, whereby operation of the keyless entry system is responsive to a receipt of said at least one coded signal.

13. The mobile communication device, according to claim 12, wherein said coded signal generating and transmitting means includes a transmitter and a processor coupled to said transmitter, said processor having means disposed therein for generating said at least one coded signal based on a predetermined code and a predetermined frequency entered by the user.

14. The mobile communication device, according to claim 12, wherein said operating means includes a switch provided within said mobile communication device and only capable of operating said coded signal generating and transmitting means.
